(19) United States
(12) Patent Application Publication
(10) Pub. No.: US 2018/0260423 A1
(43) Pub. Date: Sep. 13, 2018

(54) VERSIONED DATA UPDATING SYSTEM

(71) Applicant: ORDERMATE, Port Melbourne (AU)

(72) Inventors: Jeremy TYRRELL, Fawkner (AU); Erman BOLAT, Port Melbourne (AU); Sarah SOLIMAN, Port Melbourne (AU); Christopher BESANT, Port Melbourne (AU)

(21) Appl. No.: 15/914,406

(22) Filed: Mar. 7, 2018

(30) Foreign Application Priority Data
Mar. 7, 2017 (AU) 2017900774

(51) Int. Cl. G06F 17/30

(52) U.S. Cl. CPC G06F 17/30309; G06F 17/30321; G06F 17/30377

(57) ABSTRACT

A data versioning system for data which is not highly critical as to the time and date of a change compacts a number of data changes to data objects before storing them in a database as identifiable versions. On output from the database the data for any data object may be produced by mapping from the data object to the actual data required by a third party with the possibility of including different versions of at least some of the data required. The compaction of the changes may be managed to provide a granularity acceptable to the users.

### TECHNICAL FIELD

The invention generally relates to a versioned data updating system for versioning the updates of changes to properties of data objects and updating that data remotely. More particularly the invention relates to versioned data updating systems where the occurrence of changes to data is stored in a versioned form which does not capture each specific change to the data.

### Dictionary

A complex data object is defined as an object consisting of at least one data object having an identifier and multiple properties where at least one property has an associated value and at least one related data object in which at least one property is related to a property or identifier of the first data object.

### BACKGROUND ART

In a computer instantiated data storage system it is known to store versioned data where each data object has properties the value of which may change. Typically each time a property of a data object changes the new value of that property is stored against the datetime of that change and requests for the data object including that property return the latest version of the property. On request such a system can still return the value of each property value for any previous datetime and the datetime at which the property was changed. Equally such a system can produce the values for a selection of data objects and any requested property values of those objects.

Such data stores require a comparatively large amount of data capture and a comparatively large amount of calculation to retrieve the data for any data object which was current at any particular change. Once retrieved such data can either be output as is or merged into a report of a form required by the user. This requires further calculation.

It is further known to store only the current version of any data in a database and to provide full downloads of a complete subset of the data when any request is received for an updated data subset. Typically such an occurrence is required both when a dataset is substantiated remotely from the database and when any property value of a data set is changed. Each of these may require the transfer of a large amount of data.

It is equally known to provide a computer instantiated database for complex data objects in which the complex object consists of the equivalent of database tables with relationships between the tables which may be one-to-one, one-to-many, many-to-one or polymorphic. Such tables may include a ‘last_updated on” property which reliably stores the datetime of the last update to the table, however this does not indicate which property value was updated at that datetime and no history is normally stored.

It is also known to create an audit trail of any change to a data storage for complex objects which tracks any change to any property, however the overhead in extracting data from such an audit trail can be considerable.

Therefore a need exists for a solution to the problem of providing output data which reduces as much as possible the computing power and data retrieval processing required at the source of the data.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

### SUMMARY OF THE INVENTION

In one exemplification the invention consists in a data storage system storing changeable complex data objects as properties of the complex data objects and current values of the properties of the complex data objects and providing information from the complex data objects to at least one end user;

a time versioned updating storage system identifying in each time version which properties of a complex data object have changed within a past time span and uniquely identifying the time version, but wherein the property values of any changes in the complex data object are not stored.

Preferably a data export system is provided, the data export system supplying to an end user information on which of the property values of a complex data object have changed within a time span and which export system retrieves from the versioned updating storage system the cumulative identified property changes of a complex data object between a selected past version and a current version, retrieves from the data storage system the current values of the properties of the complex data object and exports identifiable current property values of only the cumulative identified property changes.

Preferably a data template of a complex data object is related to at least one end user and specifies which of the properties of the complex data object should be exported to the end user and wherein the data export system exports only those properties specified in the data template which have changed.

Preferably a data template related to multiple end users of a complex data object specifies which of the properties of the complex data object should be exported and where the properties required by each of the multiple end users have some common properties but differ in other properties the data template specifies both the common and all of the differing properties of the complex data object for export.

The invention may also lie in a method of storing information relating to changes in changeable complex data objects by storing within a data storage system the current properties and values of each complex data object, detecting changes to the complex data object and storing in a version storage system an indication that at least one property of the complex data object has changed within a specific time span, the indication being related to at least one schema mapping at least some properties of the complex data object wherein the indication that at least one property has changed contains no indication of the value of that property.

Preferably the invention includes indicating where a change has occurred in a complex data object property mapped in a schema mapping within a specific time span by storing in the version data storage a version identifier related to the specific time span, the schema mapping and an indication of the properties of the complex data object appearing in the schema mapping which changed within that time span.

Preferably the invention provides a system data exporter is exporting to an end user those property values whose properties appear in a schema mapping and which are indicated in one or more specified versions as having changed.

These and other features of as well as advantages which characterise the present invention will be apparent upon reading of the following detailed description and review of the associated drawings.

### BRIEF DESCRIPTION OF THE DRAWINGS

FIG. 1 is a diagram of the inventive data versioning system.

FIG. 2 is a flow chart of the allocation of an incipient version for changed properties.

FIG. 3 is a flow chart of the extraction of data to construct an output of updates for an object.

FIG. 4 is a flow chart of the conversion of incipient versions to an identifiable version.

### DESCRIPTION OF THE INVENTION

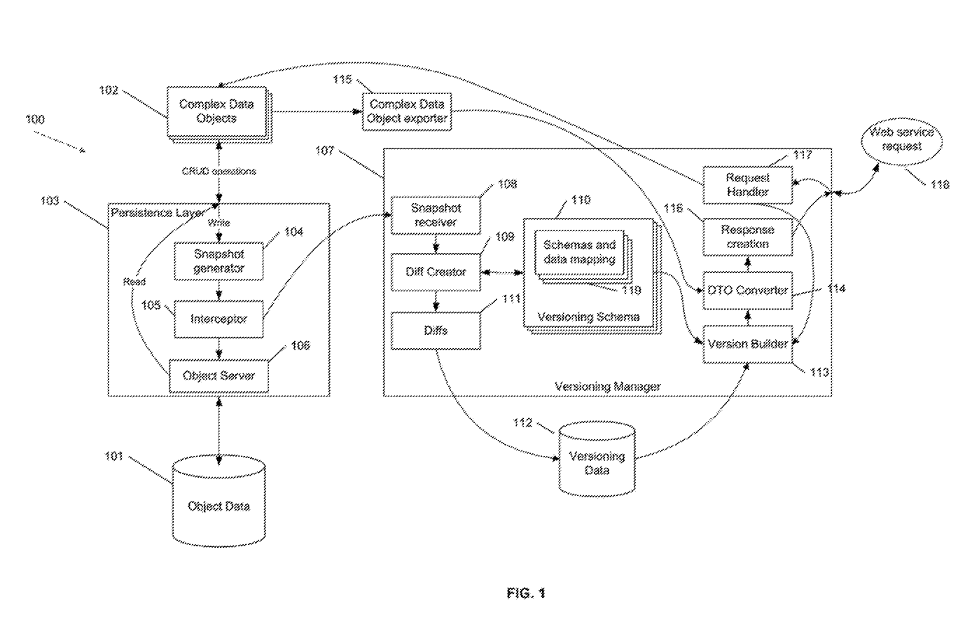

Referring now to FIG. 1 a versioned data updating system 100 in which an object database 101 stores data capable of producing complex data objects 102. Each complex data object may be made up with data from several differing data objects, where each data object may have multiple properties. Typically the data objects within one complex data object have one-to-one, one-to-many or many-to-one relationships. For instance the complex data object may be a menu, which may contain many menu items. Each menu item may contain a description, an image, a base price, a choice of chilli strength and a choice of side dishes. Each side dish may have a separate price. Any one menu item may be related to a single chilli strength choice and multiple side dish choices.

A full data upload to a remote location, a restaurant for instance, would require the transfer of the complete data record for the menu, the chilli choices and the side dishes. For a large complex data object the data upload could be considerable.

In the inventive system the initial creation of the complex data object results in a several “create” actions proceeding through persistence layer 103 to be stored in object database 101. Within the persistence layer 103 a snapshot generator 104 captures the data and structure and passes it on to interceptor 105 where the snapshot is transferred both to snapshot receiver 108 and to object server 106 to the object database 101 for storage within the database structure. Any change to the data, in the form of an update or delete action will similarly create a snapshot at snapshot generator 105 of only the changed data for transfer to snapshot receiver 108 and will be written down through the object server 106 to the object database 101.

A request for outgoing data would typically be made by requesting through the complex data object exporter 115 to the complex data objects 102 with the relevant complex data object identifier. A read action for the elements of the complex data object proceeds through the persistence layer 103 to the object server 106 and returns all the data for the complex data object.

In the inventive system the snapshot of the incoming creation or update data is transferred to snapshot receiver 108 and at differential creator 109 is compared with various versioning schema 110. Each of the versioning schema 110 holds a list of the properties within a single complex data object 102 which are required by an end user of the data. For instance one end user may not prepare meals using chilli and hence will not need to store data on the chilli heat in a meal. The versioning schema 110 for this user could therefore differ from the versioning schema 110 for an end user who does prepare meals using chilli.

For each snapshot passed to the differential creator 109 a comparison is made of each property within the complex data object snapshot and each of the schema for that complex data object. Where a property of the complex data object appears in the schema and has changed and hence appears in the complex data object snapshot a version differential is created signifying the property or properties which have changed, but NOT the changed value of the property. This version differential is stored in the versioning database 112 as a pending version, or part thereof, for that particular versioning schema 110. Since one property of one complex data object may appear in many different versioning schema 110 for many different end users with differing data needs a single property change in one complex data object may create many pending version differentials.

Subsequent changes to the same complex data object 110 will create further changes in the object database 101, further snapshots to be compared with the versioning schemas, and further pending versions of the data for that complex data object. At some point, normally when a request for update data is received from an end user, the pending version information for a complex data object is versioned. The allocation of a version identifier to each of the version differentials with a pending version indicates which data properties in a complex data object as expressed by a versioning schema 110 have changed since the last version of that versioning schema. It does not indicate the values which those data properties either had or currently have and it does not indicate precisely when the data property changed or whether it has changed more than once in the pending versions.

It is possible to go back through the versions of the versioning schema and see what data properties have changed at any version from and including the initial instantiation of that particular complex data object 102.

Information as it currently exists in the object database 101 can be provided to an end user. Typically an end user makes a web service request at 118 to a request handler 117. The request will provide as a minimum the identifier of the versioning schema for a particular complex data object 102 relevant to that particular user and the version of the schema versioning database 112 currently in use at the end user. Request handler 117 provides the information on which complex data object is required to complex data object 102 which prompts the object server 106 to read from object database 101 the data objects making up the complex data object 102. This information is passed by the complex data object handler 102 to the complex data object exporter 115. The request criteria may also include the identifier of a particular component of a complex data object where only updates relating to that component are being requested.

The request handler 117 passes to the version builder 113 the identifier of the relevant version schema and the version of that versioning schema 110 which is current at the end user. The version builder 113 reads from the versioning data the information on which data properties of that complex data object have changed since the version current at that end user. This may include merging together information from several versions of the versioning data up to and including a version which was created by the action of receiving the current request for update (the version current to the information in the object database 101).

Once the data properties in the complex data object which are relevant to the versioning schema are known, and which of these have changed is known, the information can be transferred to the data transfer converter 114 together with the current information on the complex data object 102 drawn from the complex data object exporter 115.

The data transfer converter 114 uses templates to build an output object which contains only the information relating to data properties relevant to the versioning schema 110 being used and which are shown by the merged versions to have been updated or created. The templated information (typically JSON or XML) is passed to response creator 116 and issued as a response to the web service query at 118 where the response includes the current version of the relevant versioning schema and the versioning schema identification.

To reduce the number of versioning schema which may be required it may be optimum to provide schema sharable by several different end users with slightly different data needs from the same complex data object. In such a case a schema which includes chilli choice information may also be used by a non-chilli restaurant, which can ignore that information.

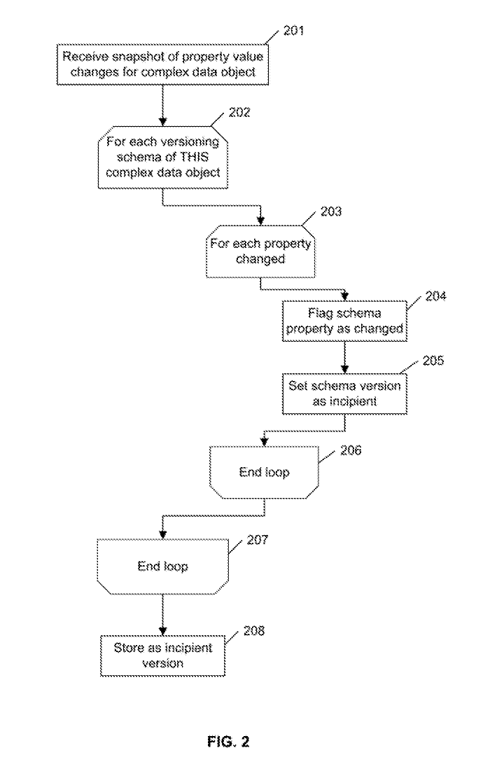

FIG. 2 follows the process of storing an indication of changings in a complex data object 102 in the versioning database 112. At 201 a snapshot is received at the differential creator 109. The differential creator 109 iterates through the versioning schema relating to the particular complex data object 102 at 202 and for each schema iterates through the properties which have changed at 203.

For each of the changed properties which appear in the versioning schema the property is flagged as changed at 204 and the schema version is set at “incipient” if not already so set. When the iterations are finished the schema version is stored as an incipient version. It will remain in this state for subsequent flaggings of other iterations where further changes to the same complex data object occur unless a version change is triggered.

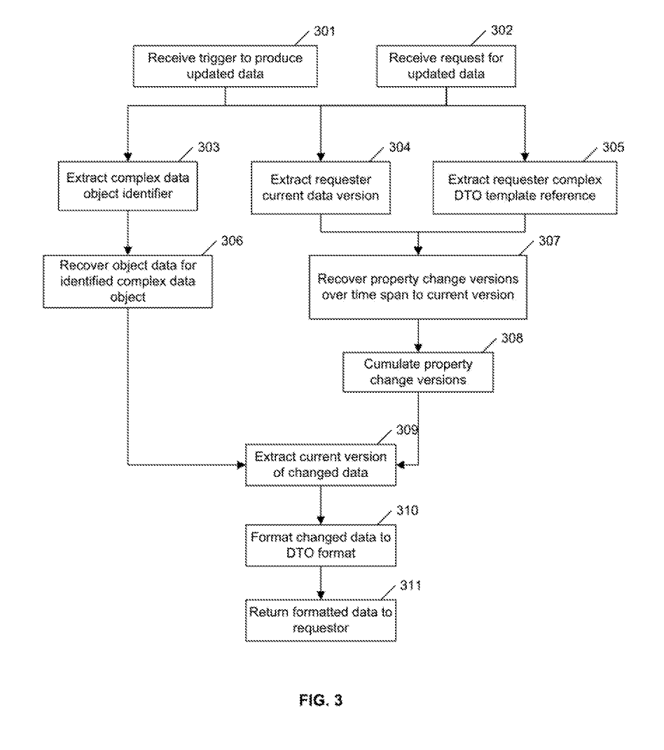

FIG. 3 provides a flow chart of the process of producing a data output to an end user. At 301 either a trigger to produce versioned data is received, for instance a requested regular update trigger, or at 302 a request is received from an end user for updated data. In either case the request will contain an identifier for the complex data object, the reference of the template which provides the data to the user and the versioning schema version currently in use at the end user.

The complex data object identifier is extracted at 302 and server to allow the recovery of the current version of the data for the complex data object from the object database 101 at 303. The end user requesters current data version is extracted at 304 and the DTO template reference at 305. The latter is particular to a versioning schema and allows the extraction from the versioning database of the versioning schema identifier and the versions associated with that identifier. From this the versions of that versioning schema can be used to identify at 307 what complex data object properties associated with the versioning schema have been changed between the end users version and the current version. It is possible that some properties and their values have changed multiple times, depending on how long an incipient version was building and what changes were made in that period.

At 307 these properties are cumulated to list all those complex data properties which must be updated at the end user and at 308 the current data for these properties is extracted from the retrieved complex data object. The data is forwarded to DTO converter 114 where it is formatted at 309 to a format suitable for return to the end user and is returned as a response at 310.

The output format is preferably a protocol which has a compact form, for instance JSON or YAML.

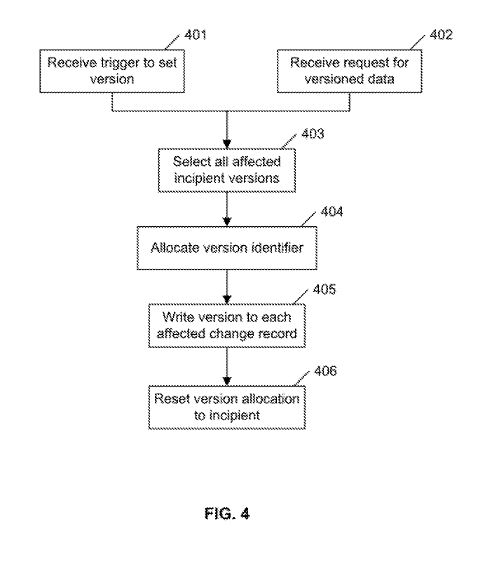

FIG. 4 provides a flowchart of the process of changing a version identifier from “incipient” to actual. At 401 either a trigger is received to set a new version, for instance on a ‘once a day’ basis or a request is received from an end user for updates to versioned data. Such request must necessarily set a version if there is any incipient version otherwise the data in the object database 101 may not match the data sent to the end user as an update

At 403 all incipient versions for that end users versioning schema are selected and at 404 a version identifier is allocated to the version to be created. The version identifier is written to each change record at 405 and the version allocator then reset so that only incipient versions will be allocated for that versioning schema.

The system may be implemented on a computer system adapted to store and maintain separately the information for the versioning data and the property and value information.

Other methods of allocating version identifiers may be used but a method which only allocates a version when output is required from the complex data object using a specific versioning schema will provide the lowest processing overhead.

Other methods of allocating new versions may be used with the critical factor being that if any values within a complex data object which are required by a particular end user have been changed then it is necessary that a version is established before data is exported to that end user.

The major advantages of the present invention are that the quantity of data exported to end users of the complex data objects is limited solely to updates, that the process of identifying these updates does not require intensive index operations on the object storage database and that the data exported to individual end users is easily limited to the updates which only they will require by the use of data templates.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the conversion system may vary dependent on the particular application for which it is used without variation in the spirit and scope of the present invention.

In addition, although the preferred embodiments described herein are directed to a converter for use in a data maintenance system, it will be appreciated by those skilled in the art that variations and modifications are possible within the scope of the appended claims.

### INDUSTRIAL APPLICABILITY

The data versioning system of the invention is used in the output of changing data with differing data changes for different users from the same data transfer information creation. This reduces the number of transformations of the same source data required to service multiple users providing efficiencies in the data transfer and additionally provides advantages in requiring less data storage space. The present invention is therefore industrially applicable.

1. A data storage system operating to store changeable complex data objects as properties of the complex data objects and current values of the properties of the complex data objects and providing information from the complex data objects to at least one end user;
a time versioned updating storage system identifying in each timed version of a complex data object which properties of the complex data object have changed within a past time span and uniquely identifying the timed version, but wherein the property values of any changes in the complex data object are not stored.

2. A data storage system as claimed in claim 1 wherein a data export system is provided, the data export system supplying to an end user information on which of the property values of a complex data object have changed within a time span and which export system retrieves from the versioned updating storage system the cumulative identified property changings of a complex data object between a selected past version and a current version, retrieves from the data storage system the current values of the properties of the complex data object and exports identifiable current property values of only the cumulative identified property changings.

3. A data storage system as claimed in claim 2 wherein a data template of a complex data object is related to at least one end user and specifies which of the properties of the complex data object should be exported to the end user and wherein the data export system exports only those properties specified in the data template which have changed.

4. A data storage system as claimed in claim 3 wherein a data template related to multiple end users of a complex data object specifies which of the properties of the complex data object should be exported and where the properties required by each of the multiple end users have some common properties but differ in other properties the data template specifies both the common and all of the differing properties of the complex data object for export.

5. A method of storing within a computer system information relating to changes in changeable complex data objects by:
storing within a data storage system the current properties and values of each complex data object;
detecting changes to the complex data object and storing in a version storage system an indication that at least one property of the complex data object has changed within a specific time span, the indication being related to at least one schema mapping at least some properties of the complex data object wherein the indication that at least one property has changed contains no indication of the value of that property.

6. A method as claimed in claim 5 including indicating where a change has occurred in a complex data object property mapped in a schema mapping within a specific time span by storing in the version data storage a version identifier related to the specific time span, the schema mapping and an indication of the properties of the complex data object appearing in the schema mapping which changed within that time span.

7. A method as claimed in claim 6 wherein a system data exporter is provided exporting to an end user those property values whose properties appear in a schema mapping and which are indicated in one or more specified versions as having changed.
